(19) United States
(12) Patent Application Publication
(10) Pub. No.: US 2017/0136606 A1
(43) Pub. Date: May 18, 2017

(54) CLAMP

(71) Applicants: HANGZHOU GREAT STAR TOOLS CO., LTD., Hangzhou City, Zhejiang Prov. (CN); HANGZHOU GREAT STAR INDUSTRIAL CO., LTD., Hangzhou City, Zhejiang Prov. (CN)

(72) Inventor: Yueming Li, Hangzhou City, Zhejiang Prov. (CN)

(21) Appl. No.: 15/322,578

(22) PCT Filed: Jul. 4, 2014
(86) PCT No.: PCT/CN2014/081629

§ 371 Date: Dec. 28, 2016

(51) Int. Cl. B25B 5/06

(52) U.S. Cl. CPC B25B 5/068

(57) ABSTRACT

The present invention provides a clamp, comprising a first clamp body, a second clamp body and a shank. The shank is configured to be passed through the first clamp body and the second clamp body. The clamp further comprises a stepping mechanism and a locking/unlocking mechanism. The stepping mechanism is comprised of a first handle, a second handle, driving sheets and a first elastic member. The first handle is pivotably mounted to the second clamp body by a pivot located on the first handle, and is configured to cooperate with the second handle. Driving sheets are mounted to the shank and contact a contact portion arranged on the first handle. A first elastic member is arranged to provide a pre-tightening force to the driving sheets to enable the driving sheets to be kept in constant contact with the contact portion, in which the pivot and the contact portion are located on the upper side of the shank. Raising the position of the pivot is beneficial to generate a larger clamping force. The clamp further comprises an adjusting mechanism for adjusting an idle stroke of the first handle, which lowers the requirement for the blanking precision of the driving sheets so as to save time and costs for the production while in the meantime generates a larger clamping force.

### FIELD OF THE INVENTION

The present invention relates to a clamping or expanding tool and, particularly, to a clamp.

### DESCRIPTION OF THE PRIOR ART

Clamps which are mainly used in the woodworking field for clamping workpieces can usually be divided into F-clamps, G-clamps and A-clamps, according to their shapes.

An F-clamp usually comprises two clamp bodies, a slidable shank and handles. By operating the handles, the two clamping chunks relatively move along the shank thus hold a workpiece firmly or maintain a distance between two parts. However, for the current F-clamp, for example the clamp described in the patent ZL201010559974.5, the upper end of the stress application handle is usually located on the slidable shank. The ratio of the operating force arm (the distance between the force applying point on the stress application handle and the pivoting point at the upper end of the stress application handle) and the acting force arm (the distance between the pivoting point at the upper end of the operating handle and the force applying position on the driving sheets) thus produced is relatively small. Therefore, by applying a force on the stress application handle, it cannot generate a large acting force at the position where the force is inputted to the driving sheets, thus is unable to generate a preferable clamping force.

Moreover, with the current F-clamp, once the driving sheets are mounted to the slidable shank, the inclination angle thereof cannot be adjusted. During the process of using the F-clamp, in order to slide the clamp bodies along the shank smoothly in an unlocked state, there is bound to be a gap between the driving sheets and the shank. In this case, there is a certain idle stroke during the process of the driving handle actuating the driving sheets to be rotated to generate a friction force with the shank. Since the inclination angle of the driving sheets is unadjustable, which means the idle stroke generated by the driving handle is also unadjustable, the existence of the idle stroke shortens the moving distance of the shank and eventually weaken the clamping force between the clamping chunks under the condition that the overall stroke of the driving handle is constant. Therefore, the current F-clamp cannot adjust the idle stroke thus is unable to adjust the clamping force.

The tight fitting between the driving sheets also plays an important role in the process of generating effective stepping. Under the condition that the driving sheets are unadjustable, the tight fitting between the driving sheets requires a high blanking precision, which undoubtedly leads to a rise in production costs.

In addition, a current clamp usually has its stationary clamping chunk mounted and fixed by providing a groove portion on the shank and a positioning member. However, such fixing method is quite time-consuming during mounting and dismounting, and it is quite hard to tell whether or not the positioning member of the clamping chunk has been inserted into the groove portion on the shank. Therefore, a quick replacement of clamping chunks cannot be realized with the current method of mounting clamping chunks.

Therefore, clamps of the prior art do not have a high conversion efficiency of the acting force applied thereto, thus is unable to generate a large clamping force. The idle stroke of the driving handle cannot be adjusted, and the requirement for the blanking precision of the driving sheets is high, and the replacement of clamping chunks is time-consuming or inconvenient, thus the switching between clamping and expanding functions is inconvenient.

### SUMMARY OF THE INVENTION

In the present invention, the upper side of the shank is referred to as the side where a workpiece is clamped. The side of the second clamp body away from the clamping chunk is referred to as the direction away from the contact surface where the second clamping chunk contacts the workpiece.

Considering the defects that a clamp in prior art cannot generate a larger clamping force, the idle stroke of the driving handle cannot be adjusted, the requirement for the blanking precision of the driving sheets is high, the switching between clamping and expanding functions is difficult, the present invention provides a clamp that can adjust the idle stroke and generate a larger clamping force.

The present invention provides a clamp comprising a first clamp body, a second clamp body and a shank. The shank is configured to be passed through the first clamp body and the second clamp body. The clamp also comprises a stepping mechanism which comprises a first handle, a second handle, driving sheets and a first elastic member. The first handle is pivotably mounted to the second clamp body by a pivot on the first handle, and is configured to cooperate with the second handle. The driving sheets are mounted to the shank and contact with a contact portion arranged on the first handle. The first elastic member is arranged to provide a pre-tightening force to the driving sheets to enable the driving sheets to be kept in constant contact with the contact portion, in which, the pivot and the contact portion are positioned to the upper side of the shank. The clamp also comprises a locking/unlocking mechanism, which is mounted to the shank.

Further, a contact portion is positioned to the lower side of the pivot.

Further, one side of the first elastic member contacts the driving sheets on the opposite side to a position where the contact portion contacts the driving sheets. The length of the elastic member is configured to be smaller than its free length.

Preferably, the first elastic member is a first spring.

Further, a through hole is configured in the middle of the driving sheets. The shank is passed through the through hole. A gap is reserved between the through hole and the upper side of the shank.

Preferably, the driving sheets are multi-stacked layers in use. Preferably, the driving sheets are four stacked layers in use.

Further, the clamp also comprises an adjusting mechanism for adjusting the idle stroke of the first handle. The adjusting mechanism is mounted to the second clamp body and is configured to be displaceable along the direction of the extension of the shank.

Further, the adjusting mechanism contacts the lower part of the driving sheets, and is positioned on the same side of the driving sheets as the contact portion.

Preferably, the adjusting mechanism comprises an adjusting screw and an adjusting nut. The adjusting screw is mounted to the second clamp body. The adjusting nut is mounted to the adjusting screw at the end near the driving sheets, and is configured to be displaceable along the adjusting screw.

Preferably, the adjusting mechanism is an adjusting bolt directly mounted to the second clamp body, which is configured to be displaceable.

Preferably, the adjusting screw or the adjusting bolt is configured to be surrounded by an elastic member. The elastic member is configured to prevent the rotation of the adjusting nut or the adjusting bolt during operation of the clamp.

Further, a locking/unlocking mechanism comprises a third handle, locking sheets, a fixed member and a third elastic member. The third handle and the fixed member are mounted to the second clamp body and positioned on the same side of the locking sheets. The locking sheets are mounted to the shank with the upper part thereof contacting the fixed member. The third elastic member is configured to provide a pre-tightening force to arrange the locking sheets to be inclined relative to the shank.

Further, the locking/unlocking mechanism also comprises a second elastic member, which provides a pre-tightening force to the third handle to cause the third handle not to contact the locking sheets when in a free state.

Further, the locking/unlocking mechanism also comprises a fourth elastic member, which provides a pre-tightening force to the locking sheets to cause the locking sheets to be kept in constant contact with the fixed member.

Preferably, the locking sheets are multi-stacked layers in use. Preferably, the locking sheets are triple-stacked layers in use.

Further, the first clamp body comprises a pushbutton, which is configured such that when it is pressed down, the first clamp body can be mounted or dismounted.

Further, a through hole is configured in the shank, and a protrusion is configured to the back side of the pushbutton. The protrusion is snap-fitted with the through hole.

Further, a positioning member is configured at a side, close to the middle of the shank, of the through hole for positioning the first clamp body.

The clamp in the present invention raises the pivot point of the first handle from the position near the slidable shank to the upper side of the slidable shank (i.e. the side where a workpiece is clamped) and arranges the contact portion, which provides acting force to the driving sheets, to be also to the upper side of the shank. Such configuration can lengthen the operating force arm (the distance from the force inputting position of the first handle to the center of the pivot). When the operating force arm becomes larger, a force applied on the first handle can be effectively converted to a clamping force. After such configuration, the clamping force can be easily raised to more than 600 lbs. Moreover, an adjusting mechanism is arranged for the driving sheets in the clamp of the present invention. The angle between the driving sheets and the shank can be adjusted by the displacement of the adjusting mechanism, so that the idle stroke can be adjusted. Besides, the configuration of the adjusting mechanism also lowers the requirement for the blanking precision of the driving sheets and the difficulty of processing the workpieces and thus saves costs and time. With a pushbutton arranged on the first clamp body, a protrusion to the back side thereof is fitted with the through hole in the shank. The position of the clamping chunk is first positioned by a positioning pin, and then the first clamp body is fixed by releasing the pushbutton. Such configuration enables a fast replacement of the first clamp body and realizes a fast switch between the clamping and expanding functions.

### BRIEF DESCRIPTION OF THE DRAWINGS

FIG. 1 is a schematic view of a clamp in an embodiment of the present invention in a free state;

FIG. 2 is an exploded schematic view of the stepping mechanism in FIG. 1;

FIG. 3 is a schematic view of the first handle in FIG. 1;

FIG. 4 is a schematic view of the angle formed between the driving sheets and the shank;

FIG. 5 is a schematic view of a clamp in an embodiment of the present invention when clamping a workpiece;

FIG. 6 is a schematic view of the adjusting mechanism in FIG. 1;

FIG. 7 is a schematic view of the locking/unlocking mechanism in FIG. 1;

FIG. 8 is an exploded schematic view of the locking/unlocking mechanism in FIG. 7;

FIG. 9 is an exploded schematic view of the first clamp body in FIG. 1; and

FIG. 10 is a sectional view of the first clamp body in FIG. 1.

### DETAILED DESCRIPTION OF THE PREFERRED EMBODIMENTS

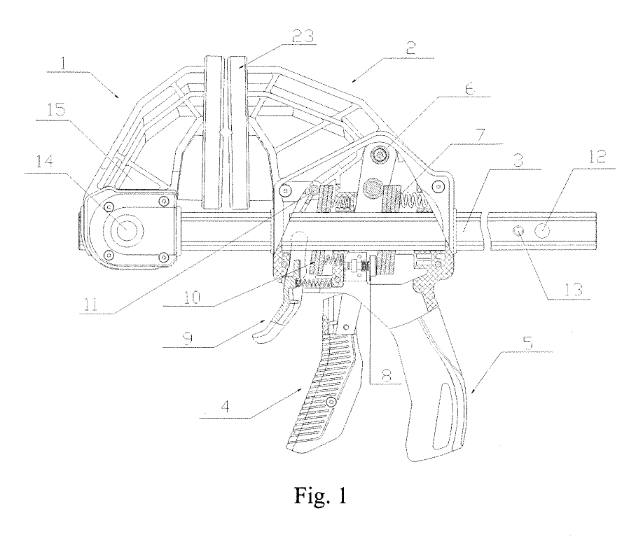

As shown in FIG. 1, a clamp of the present invention comprises a first clamp body 1, a second clamp body 2, a shank 3, a first handle 4, and a second handle 5. The first clamp body 1 is mounted to either end of the shank 3. A through hole is configured on the second clamp body 2 and the shank 3 is passed through the second clamp body 2 therethrough. The first clamp body 1 and the second clamp body 2 can be arranged facing toward or away from each other. When the first clamp body 1 and the second clamp body 2 are arranged facing toward each other, they can be used to hold tightly a workpiece to be processed. When the first clamp body 1 and the second clamp body 2 are arranged facing away from each other, they can be used to expand or maintain a distance between two parts.

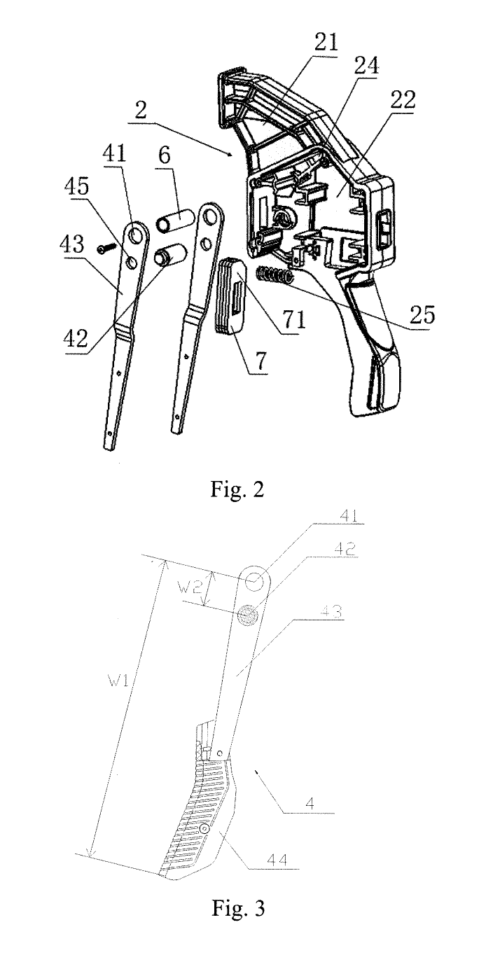

As shown in FIG. 1 and FIG. 2, a clamping chunk 23 is mounted to the upper part 21 of the second clamp body 2. The upper part 21 of the second clamp body 2 extends in a direction away from the clamping chunk 23 to form an accommodation space 22 of the second clamp body 2. The second handle 5 extends outward from the accommodation space 22 of the second clamp body 2 and extends in an opposite direction of the clamping chunk 23 of the second clamp body 2. The accommodation space 22 of the second clamp body 2 mainly accommodates part of the first handle 4, driving sheets 7, locking sheets 10 and part of the third handle 9. An upper end of the accommodation space 22 of the second clamp body 2 is configured with a protrusion 24, which can accommodate the upper end part of the first handle 4.

In a preferred embodiment, the protrusion 24 is near a side of the upper part of the second clamp body 2 away from the clamping chunk 23.

As shown in FIG. 1-3, the first handle 4 and the second handle 5 are correspondingly arranged. The first handle 4 is assembled from two upper parts 43 and one lower part 44. The two upper parts 43 are separately mounted to the insides of the lower part 44. The upper parts 43 and the lower part 44 of the first handle 4 can be made of the same material. In a preferred embodiment, the upper parts 43 and the lower part 44 of the first handle 4 are made of different materials. The upper parts 43 of the first handle 4 are made of a material with high strength, such as high-carbon steel. While the lower part 44 of the first handle 4 can be made of a material with light weight and high strength, such as ABS plastic. When the upper parts 43 of the first handle 4 are made of a material with high strength, the thicknesses can be appropriately reduced without occurrence of breakage of the upper parts 43 of the first handle 4 during operation with the clamp. Since the lower part 44 of the first handle 4 is a grip portion, materials that provide larger friction, such as plastic, rubber, etc., can be coated thereon or inlaid in the position where fingers contact. Patterns can also be added on the lower part 44 to increase the friction and prevent slipping. The upper parts 43 and the lower part 44 of the first handle 4 can be connected by riveting, welding or nutting, among which detachable connections are preferred so that the lower part 44 of the first handle 4 can be replaced in case of damage.

As shown in FIG. 2, a first hole 41 is configured at an end part of the upper part 43 of the first handle 4. A pivot 6 passes through the first holes 41 and connects the two upper parts 43 together. A through hole is configured in the pivot 6 and a protrusion portion is configured in the accommodation space 22 of the second clamp body 2. The protrusion portion can tightly fit with the through hole in the pivot 6, such that the first handle 4 is mounted to the second clamp body 2. In a preferred embodiment, the protrusion portion of the second clamp part 2 is positioned in the protrusion 24 of the upper end of the accommodation space 22 of the second clamp body 2. The pivot 6 is positioned to the upper side of the shank 3, i.e. to the side where a workpiece is clamped.

A second hole 45 is configured to the lower side of the first hole 41 of the first handle 4. A contact portion 42 is mounted in the second holes 45 and also positioned to the upper side of the shank 3, i.e. to the side where a workpiece is clamped. The contact portion 42 can be a cylindrical member, with the diameters of the cylinders at both ends thereof being less than the diameter of the cylinder in the middle. The diameters of the cylinders at both ends are the same or substantially the same as that of the second holes 45. The surface of the cylinder in the middle of the contact portion 42 comes into contact with one side of the upper part 71 of the driving sheets 7.

In another embodiment, the contact portion 42 can be two separate members respectively mounted to the upper parts 43 of the two first handles 4, the diameter of the cylinder of one end thereof being the same as that of the second through hole 45, and the diameter of the cylinder of the other end being greater than that of the second through hole 45. The cylinder with the same diameter as that of the second through hole 45 is fitted with the second through hole 45. The cylinder with a diameter greater than that of the second through hole 45 comes into contact with one side of the upper part 71 of the driving sheets 7.

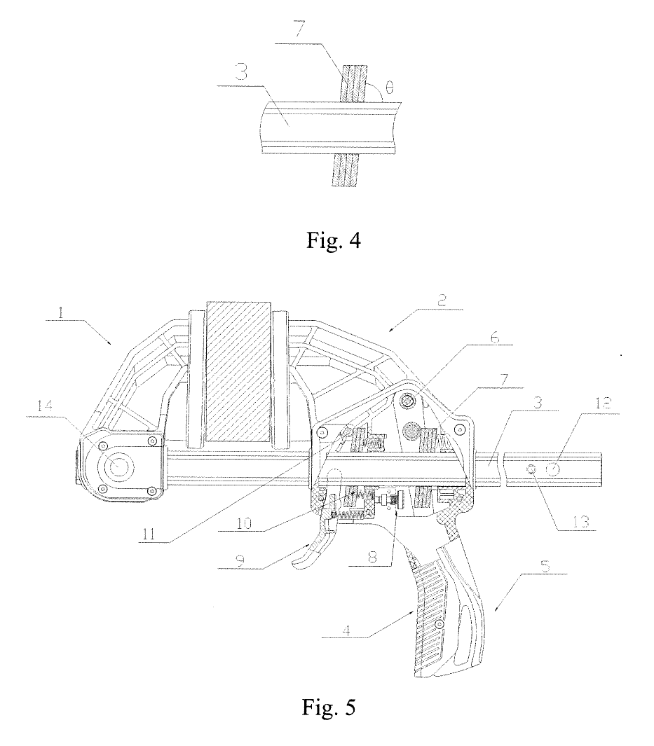

The other side of the driving sheets 7 (i.e. the opposite side of the side, of the contact portion 42, coming into contact with the driving sheets 71) comes into contact with one side of a first spring 25. The other side of the first spring 25 comes into contact with the second clamp body 2. The first spring 25 provides a certain pre-tightening force for the driving sheets 7, and the driving sheets 7 can come into contact with the contact portion 42 when the clamp is in a free state. The driving sheets 7 are in a layered structure, generally rectangular in shape and configured with a bore through the middle. In this embodiment, the bore in the driving sheets 7 is rectangular. As shown in FIG. 4, the shank 3 passes through the driving sheets 7 via the bore. The driving sheets 7 are arranged to be inclined, the upper and lower edges of the bore thereof coming into contact with the shank 3, forming an angle θ between the driving sheets 7 and the shank 3.

Referring to FIG. 1 and FIG. 2, a stepping mechanism is formed by the first handles 4, the pivot 6, the contact portion 42, the driving sheets 7 and the first spring 25 together. During operation, the operator's palm is at the second handle 5, applying a force to the first handle 4 with fingers. The first handle 4 rotates about the pivot 6 in a direction toward the second handle 5. At the same time, the contact portion 42 moves along with the movement of the first handle in a direction toward the second handle 5, generating an acting force to the upper part 71 of the driving sheets 7 towards the second handle 5 during the movement, and at the time, the driving sheets 7 compresses the first spring 25, the inclination angle of the driving sheets 7 becomes greater, and the angle θ between the driving sheets 7 and the shank 3 becomes smaller. The friction at the contact point between the bore edges of the driving sheets 7 and the shank 3 causes the second clamp body 2 to produce a stepping movement relative to the shank 3. During the stepping movement, the first spring 25 provides a space for the inclining of the driving sheets 7. When the force applied to the first handle 1 by the operator disappears, the first handle 1 is restored to the initial position, the first spring 25 is restored to the initial state, and the angle θ between the driving sheets 7 and the shank 3 is restored. This process is repeated until the first clamp body 1 and the second clamp body 2 is clamping a workpiece tightly. FIG. 5 is a schematic view of a clamp in an embodiment of the present invention in the clamping state.

Among which, as shown in FIG. 3, the length from the pivot 6 to the force input position at the lower part 44 of the first handle 4 is an operating force arm W1; and the length from the pivot 6 to the contact portion 42 is an acting force arm W2. By means of the lever transmission ratio of the operating force arm W1 to the acting force arm W2, the first clamp body 1 and the second clamp body 2 are enabled to move toward or away from each other along the shank 3, so as to realize the function of clamping or expanding. Since the pivot 6 is positioned above the contact portion 42 and near the protrusion 24 in the accommodation space 22 of the second clamp body 2, the operating force arm W1 is increased in comparison with the clamp of the prior art, of which the pivot 6 is positioned under the shank 3, such that, in comparison with a conventional clamp with the pivot under the shank 3, the clamp of this invention can generate a larger force to the driving sheets through the contact portion when a same force is applied to the first handle 4, thus generate a larger clamping force.

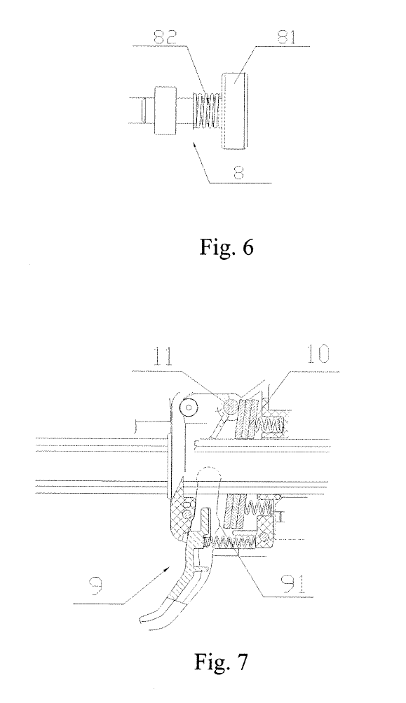

As shown in FIG. 1, an adjusting mechanism 8 is configured in the second clamp body 2 to adjust the idle stroke. When a force is applied to the second handle 4, the second handle 4 pivots about the pivot 6, and presses the driving sheets 7 to cause it to incline. Because a certain gap is reserved between the driving sheets 7 and the shank 3 to allow a movement of the second clamp body 2 forward and backward along the shank 3 under certain circumstances, so the driving sheets 7 will first be inclined by a certain angle but cannot produce a friction relative to the shank 3 to cause the shank 3 to move in relation to the second clamp body 2, and only when the driving sheets 7 is further inclined to a certain degree, the friction can then be produced between the driving sheets 7 and the shank 3, so as to cause the movement of the second clamp body 2 in relation to the shank 3. The period of stroke where the second handle 4 causes the driving sheets 7 to rotate without producing relative movement between the second clamp body 2 and the shank 3 is the idle stroke. Since the stroke space for the pivoting of the second handle 4 is limited and the clamping force generated between the first clamp body 1 and the second clamp body 2 utilizes the elastic deformation of the clamp bodies, the magnitude of the clamping force is depended on the displacement of the shank 3 caused by the second handle 4 pushing the driving sheets 7. In order to enhance the clamping force, the effective stroke of the second handle 4 is required to be increased. The displacement of the adjusting mechanism 8 can take place in the directions extending toward both ends of the shank 3 so as to adjust the inclination angle of the driving sheets 7. When the angle θ formed between the driving sheets 7 and the shank 3 becomes smaller, the purpose of decreasing the idle stroke can be realized. The adjusting mechanism 8 can be a combination of an adjusting nut and an adjusting screw, and can also be a bolt. In an embodiment of the present invention, as shown in FIG. 6, the adjusting mechanism 8 comprises an adjusting nut 81, an adjusting screw 82, and an elastic member surroundingly configured about the adjusting screw 82. The elastic member can provide a certain pre-tightening force to prevent the rotation of the adjusting nut 81 during operation, and thus prevent the failure of the adjusting mechanism. The adjusting screw 82 is mounted in the accommodation space 22 of the second clamp body 2, and is positioned at the lower side of the shank 3, at the same side of the driving sheets 7 as the contact portion 42 of the first handle 4. The adjusting nut 81 is mounted to the adjusting screw 82. After the assembly of the clamp, if the angle θ formed between the driving sheets 7 and the shank 3 is too large, causing a large idle stroke, to generate a desired clamping force, the adjusting nut 81 can then be rotated to cause the adjusting nut 81 to move along the adjusting screw 82 toward a position away from the driving sheets, so that the angle θ formed between the driving sheets 7 and the shank 3 is decreased to decrease the idle stroke. When the adjusting nut 81 is closest to the adjusting screw 82, the angle θ formed between the driving sheets 7 and the shank 3 is at the minimum. Correspondingly, the second handle 4 has a minimum idle stroke at this moment, thus increases the effective clamping force and the working efficiency of the clamp during the clamping or expanding process. On the contrary thereto, after the assembly of the clamp, if the angle θ between the driving sheets 7 and the shank 3 is so small that friction and relative movement are produced between the driving sheets 7 and the shank 3 when the second handle 4 starts to pivot and to press the driving sheets 7 to cause it to incline, in this case, the second clamp body 2, with no other obstruction, is not capable of smoothly move forward and backward along the shank 3, which is disadvantageous to quickly adjusting the distance between two clamping chunks. Therefore, the adjusting mechanism 8 needs to be adjusted so that the adjusting nut 81 is displaced towards the direction away from the adjusting screw 82 to increase the angle θ formed between the driving sheets 7 and the shank 3, so that a gap exists between the driving sheets 7 and the shank 3. The existence of the adjusting mechanism 8 can also lower the requirement for the blanking precision of the driving sheets 7. In an embodiment of the present invention, the driving sheets 7 are four stacked layers in use. When in use with stacked layers, if the blanking precision of the driving sheets 7 is high, a gap is prone to be formed between two driving sheets, which reduces the friction formed between the driving sheets 7 and the shank 3. And by the adjusting effect of the adjusting mechanism 8, the angle θ between the driving sheets 7 and the shank 3 can be adjusted so as to produce an effective friction.

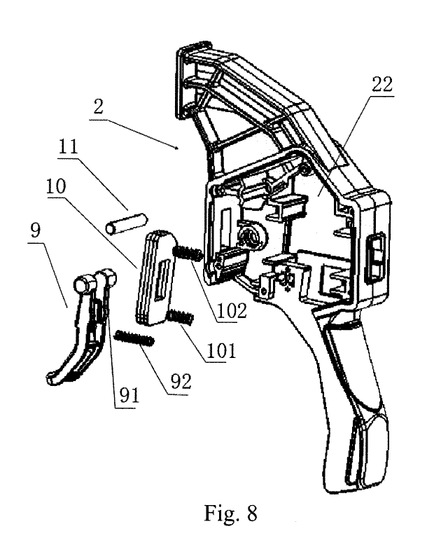

As shown in FIG. 7 and FIG. 8, a locking/unlocking mechanism is configured in the second clamp body 2. The locking/unlocking mechanism is comprised of a third handle 9, locking sheets 10 and a fixed rod 11, in which the third handle 9 is pivotably mounted to the second clamp body 2. The cross section of the third handle 9 is U-shaped in structure, and protrusion portions 91 are configured on both sides of the U-structure. One end of the second spring 92 contacts the inner wall of a groove, and the other end contacts a preformed protrusion portion of the second clamp body 2. When the clamp is in a free or clamped state, the second spring 92 maintains the third handle 9 to be unmovable. The protrusion portion 91 is arranged to be able to contact one side of the lower part of the locking sheets 10 in certain circumstances. Similar to the driving sheets 7, the locking sheets 10 are configured with a through hole, through which the shank 3 is passed through the locking sheets 10. One side of the upper part of the locking sheets 10 contacts the fixed rod 11. The fixed rod 11 is fixedly mounted in the accommodation space 22 of the second clamp body 2. The other side of the lower part of the locking sheets 10 contacts one end of a third spring 101, and the other end of the third spring 101 contacts the second clamp body 2. The other side of the upper part of the locking sheets 10 contacts one end of a fourth spring 102, and the other end of the fourth spring 102 contacts the second clamp body 2. The fourth spring 102 provides a certain pre-tightening force to the locking sheets 10 to enable the locking sheets 10 to come into contact with the fixed rod 11 tightly. The third spring 11 is compressible, providing possibility for change of the inclination angle of the locking sheets 10. In an embodiment of the present invention, the locking sheets 10 are triple stacked layers in use.

When a force is applied to the third handle 9, the third handle 9 pivots about the portion of its upper end and connected to the housing of the second clamp body 2 towards the second handle 5, and compresses the second spring 92 into contraction. Thereafter, the protrusion portions 91 on the third handle 9 apply a force to the lower part of the locking sheets 10, causing the lower part of the locking sheets 10 to compress the third spring 101 and to be in a swinging movement toward the second handle 5. Since the upper part of the locking sheets 10 contacts the fixed rod 11, when the lower part of the locking sheets 10 swings, the upper part of the locking sheets 10 has a certain rotation relative to the fixed rod 11. At this moment, the fourth spring 102 provides a certain buffering effect. Under the act of a force, the angle formed between the locking sheets 10 and the shank 3 is gradually expanded to a right angle, and the friction between the locking sheets 10 and the shank 3 decreases until eventually vanishes. Meanwhile, since a gap is reserved between the driving sheets 7 and the shank 3, the second clamp body 2 can move smoothly forward and backward along the shank 3. Correspondingly thereto, when no acting force is applied to the third handle 9, a certain friction exists between the locking sheets 10 and the shank 3, therefore, when a force is applied to the second handle 2 to enable friction between the driving sheets 7 and the shank 3 so as to realize stepping, the second clamp body 2 will only move fast toward the first clamp body 1, and will not move away from the first clamp body 1.

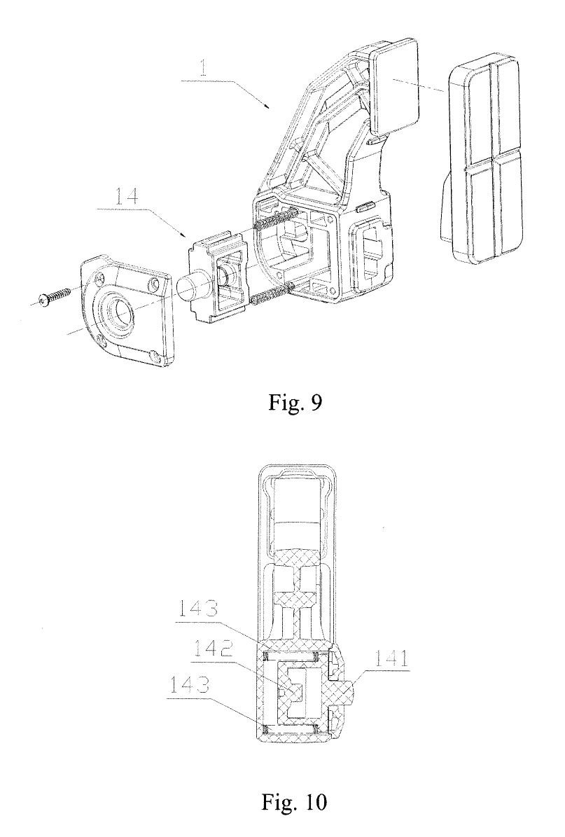

As shown in FIG. 9 and FIG. 10, a through hole is configured in the lower part of the first clamp body 1, through which the shank 3 is passed through the first clamp body 1. A pushbutton structure 14 is also configured in the first clamp body 1, which comprises a pushbutton 141, a protrusion 142 positioned at the rear part of the pushbutton and springs 143 on both sides of the pushbutton 141. In a preferred embodiment, the centers of the pushbutton 141 and the protrusion 142 are on a same axis, and the protrusion 142 is cylindrical. A through hole 12 is configured on the shank 3 in the position near both ends thereof. The protrusion 142 can be inserted into the through hole 12, performing an effect of fast connecting the first clamp body 1 to the shank 3.

In a preferred embodiment, a positioning member 13 is configured on the shank 3 to the side of the through hole 12 near the center of the shank 3. The positioning member 13 is fitted with a groove that is in the through hole of the first clamp body 1 and is arranged on the side wall of the first clamp body 1.

When the first clamp body 1 is required to be fast mounted or dismounted, the operator applies a force to the pushbutton 141 in a direction toward the shank 3, and the springs 143 on both sides of the pushbutton are compressed, so that the protrusion portion 142 detaches from the through hole 12 in the shank 3 along the direction of the force applied to the pushbutton 141 so as to dismount the first clamp body 1. When mounting the first clamp body 1, the pushbutton 141 of the pushbutton structure 14 of the first clamp body 1 is first pressed down, and the shank 3 is inserted from the opening of the first clamp body 1. The positioning member 13 located on the shank 3 slides into the groove along the groove located in the through hole of the first clamp body until it reaches the bottom, and then the pushbutton 141 is released, the protrusion 142 can be inserted into the through hole 12 of the shank 3, realizing fast mounting of the first clamp body.

The present invention has been described with reference to the preferred embodiments. It is understood that changes and modifications can be made by an ordinary person skilled in the art according to the above conception without creative work. Thus technical solutions made by a person skilled in the art through logical analysis, reasoning or limited experiments according to the above conception should be within the scope of the claims.

1. A clamp comprising a first clamp body, a second clamp body and a shank, the shank being configured to be passed through the first clamp body and the second clamp body, characterized in that, the clamp further comprises:
a stepping mechanism comprising a first handle, a second handle, driving sheets and a first elastic member, the first handle being pivotably mounted to the second clamp body by a pivot on the first handle and being configured to cooperate with the second handle, the driving sheets being mounted to the shank and contacting a contact portion arranged on the first handle, the first elastic member being arranged to provide a pre-tightening force to the driving sheets to enable the driving sheets to be kept in constant contact with the contact portion, wherein the pivot and the contact portion being positioned to the upper side of the shank; and
a locking/unlocking mechanism mounted to the shank.

2. A clamp according to claim 1, characterized in that, the contact portion is positioned to the lower side of the pivot.

3. A clamp according to claim 1, characterized in that, one side of the first elastic member contacts the driving sheets on the opposite side to a position where the contact portion contacts the driving sheets, the length of the elastic member being configured to be smaller than the free length of the elastic member.

4. A clamp according to claim 1, characterized in that, the first elastic member is a first spring.

5. A clamp according to claim 1, characterized in that, a through hole is configured in the middle of the driving sheets, the shank being passed through the through hole, a gap being reserved between the through hole and the upper side of the shank.

6. A clamp according to claim 1, characterized in that, the driving sheets are multi-stacked layers in use.

7. A clamp according to claim 1, characterized in that, the clamp further comprises an adjusting mechanism for adjusting an idle stroke of the first handle, the adjusting mechanism being mounted to the second clamp body and being configured to be displaceable along the direction of the extension of the shank.

8. A clamp according to claim 7, characterized in that, the adjusting mechanism contacts the lower part of the driving sheets, and is on the same side of the driving sheets as the contact portion.

9. A clamp according to claim 7, characterized in that, the adjusting mechanism comprises an adjusting screw and an adjusting nut, the adjusting screw being mounted to the second clamp body, the adjusting nut being mounted to the adjusting screw at an end near the driving sheets, the adjusting nut being configured to be displaceable along the adjusting screw.

10. A clamp according to claim 7, characterized in that, the adjusting mechanism is an adjusting bolt directly mounted to the second clamp body, the adjusting bolt being configured to be displaceable.

11. A clamp according to claim 9 or claim 10, characterized in that, the adjusting screw or the adjusting bolt is configured to be surrounded by an elastic member, the elastic member being configured to prevent the rotation of the adjusting nut or the adjusting bolt during operation of the clamp.

12. A clamp according to claim 1, characterized in that, the locking/unlocking mechanism comprises a third handle, locking sheets, a fixed member and a third elastic member, the third handle and the fixed member being mounted to the second clamp body and on the same side of the locking sheets, the locking sheets being mounted to the shank, the upper part of the locking sheets contacting the fixed member, the third elastic member being arranged to provide a pre-tightening force to arrange the locking sheets to be inclined relative to the shank.

13. A clamp according to claim 12, characterized in that, the locking/unlocking mechanism further comprises a second elastic member, the second elastic member providing a pre-tightening force to the third handle to cause the third handle not to contact the locking sheets when in a free state.

14. A clamp according to claim 12, characterized in that, the locking/unlocking mechanism further comprises a fourth elastic member, the fourth elastic member providing a pre-tightening force to the locking sheets to cause the locking sheets to be kept in constant contact with the fixed member.

15. A clamp according to claim 12, characterized in that, the locking sheets are multi-stacked layers in use.

16. A clamp according to claim 1, characterized in that, the first clamp body comprises a pushbutton, the pushbutton being configured such that, when pressed down, the first clamp body can be mounted or dismounted.

17. A clamp according to claim 16, characterized in that, a though hole is configured in the shank, a protrusion is configured to the back side of the pushbutton, the protrusion being snap-fitted with the through hole.

18. A clamp according to claim 17, characterized in that, a positioning member is configured at a side, close to the middle of the shank, of the through hole for positioning the first clamp body.

19. A clamp according to claim 10, characterized in that, the adjusting screw or the adjusting bolt is configured to be surrounded by an elastic member, the elastic member being configured to prevent the rotation of the adjusting nut or the adjusting bolt during operation of the clamp.
